(19) United States
(12) Patent Application Publication
(10) Pub. No.: US 2024/0116738 A1
(43) Pub. Date: Apr. 11, 2024

(54) CRANE

(71) Applicant: Hans Künz GmbH, Hard (AT)

(72) Inventors: David MOOSBRUGGER, Schwarzenberg (AT); Johannes Karl EBERHARTER, Hard (AT); Lukas FINK, Nüziders (AT)

(73) Assignee: Hans Künz GmbH, Hard (AT)

(21) Appl. No.: 18/480,810

(22) Filed: Oct. 4, 2023

(30) Foreign Application Priority Data
Oct. 7, 2022 (AT) A 195/2022

(51) Int. Cl. B66C 13/46; B66C 17/20; B66C 19/00; H04N 5/262; H04N 23/90

(52) U.S. Cl. CPC B66C 13/46; B66C 17/20; B66C 19/007; H04N 5/2624; H04N 23/90

(57) ABSTRACT

A crane with at least one main carrier which is moveable and a crane trolley which is mounted on the at least one main carrier for movement, a winch carrier being fastened to the crane trolley, and a load suspension apparatus which is moveable up and down in the vertical direction by cables hanging on the winch carrier, the load suspension apparatus having gripping tools for releasably gripping a load. The crane has at least one camera and at least one control stand for a crane driver, and the control stand has at least one screen. At least one assistance graphic can be superimposed on the at least one screen onto the display of the image recorded instantaneously by the camera, as an aid for the crane driver for orienting the load suspension apparatus and/or the gripping tool of the load suspension apparatus relative to the load to be gripped.

### CROSS-REFERENCE TO RELATED APPLICATIONS

This application claims priority from Austrian Patent Application No. A 195/2022, filed Oct. 7, 2022, which is incorporated herein by reference as if fully set forth.

### TECHNICAL FIELD

The present invention relates to a crane with at least one main carrier which can be moved back and forth along a first direction, and with a crane trolley which is mounted on the at least one main carrier such that it can be moved back and forth along a second direction, the first direction and the second direction being oriented orthogonally with respect to one another, and a winch carrier being fastened, in particular rotatably, to the crane trolley, and a load suspension apparatus which can be moved up and down in the vertical direction by means of cables hanging on the winch carrier, the load suspension apparatus having gripping tools for releasably gripping a load, in particular a semi-trailer and/or a container, and the crane having at least one camera and at least one control stand for a crane driver for moving the at least one main carrier, the crane trolley and the load suspension apparatus, and for operating the gripping tools of the load suspension apparatus, and the control stand having at least one screen for displaying the image recorded in each case instantaneously by the camera.

Moreover, the invention also relates to a method for operating a crane.

### BACKGROUND

Cranes of this type can be configured, for example, as a gantry crane or else as an overhead crane. WO 2019/118992 discloses gantry cranes. These cranes are used for loading loads such as semi-trailers and/or containers, and are controlled by a crane driver by means of a control stand. It is known in practice for cranes of this type to be equipped with cameras, in order to simplify the orientation of the load suspension apparatus and/or the gripping tools during loading and/or unloading for the crane driver. In the prior art, however, additional support staff are often still necessary, in order to direct the crane driver.

### SUMMARY

It is an object of the invention to propose an improvement which assists the crane driver in an even more improved manner to orient the load suspension apparatus and/or its gripping tools in an optimum manner in order to receive or unload the load, in particular of semi-trailers and/or containers.

For this purpose, the invention provides, for cranes of the type mentioned at the outset, that at least one assistance graphic can additionally be superimposed on the at least one screen onto the display of the image recorded in each case instantaneously by the camera, as an aid for the crane driver for orienting the load suspension apparatus and/or the gripping tool of the load suspension apparatus relative to the load to be gripped.

Simply put, the invention therefore provides that at least one assistance graphic is superimposed into the image of the camera as aiming aid, in order thus to assist the crane driver in an even more improved manner during the orientation of the load suspension apparatus and/or the gripping tool of the load suspension apparatus. As a result, support staff for directing the crane driver can even be dispensed with in favorable embodiments of the invention.

The method according to the invention for operating a crane according to the invention correspondingly provides that at least one assistance graphic is additionally superimposed on the at least one screen into the display of the respective image recorded in each case instantaneously by the camera, as an aid for the crane driver for orienting the load suspension apparatus and/or the gripping tool of the load suspension apparatus relative to the load to be gripped, preferably relative to the semi-trailer and/or container to be gripped.

The features mentioned in the following text of preferred variants of cranes according to the invention correspondingly also result in the preferred embodiments of the method according to the invention.

In the case of the invention, the cameras as a rule record a chronological sequence of images. Depending on the speed of the recording and the display, this sequence of images is still presented as a sequence of individually recognizable images or as a film for the crane driver.

The invention can be used for loading different loads, in particular both containers and semi-trailers. Containers are, as a rule, vessels which can be transported, for example, on low-loaders which are known per se by means of truck, tractor unit, terminal tractor or the like, or on railway trailers, but also by ship. The containers are preferably what are known as ISO containers or shipping containers. In contrast, semi-trailers have dedicated wheels, with the result that they can be hooked directly to a truck. Cranes according to the invention can also specially be used, however, to load semi-trailers of this type onto ships and/or railway trailers.

The load suspension apparatus are frequently also called spreaders. In the case of the invention, they can also have different types of gripping tools for gripping the load, in particular the semi-trailers and/or containers. For example, the load suspension apparatus can have tong arms, mounted pivotably as gripping tools, for gripping a semi-trailer. In the case of this type, the at least one camera can also be arranged on at least one of the tong arms so as to look horizontally to the side. It is particularly preferably provided in this context that the camera is arranged in a lower end region of the tong arm in the region of a tong base of the tong arm. In addition to and/or instead of this, the load suspension apparatuses of cranes according to the invention can also, however, have locking pins, which are also called twistlocks, as gripping tools, in order to engage by way of them into corresponding corner fittings, which are also called corner casts, of containers. In order for it to be possible for the position of the locking pins to be adapted relative to one another on container types of different length, the load suspension apparatus can be of telescopic configuration. It can have, for example, gripper carriers, on which the locking pins are situated, it being possible for the gripper carriers to be retracted into the load suspension apparatus and extended out of the latter by means of telescopes, in order to transport containers of different length. In preferred embodiments, in the case of which the cameras are situated on the load suspension apparatus, the cameras can also be arranged on the gripper carriers, in particular in the vicinity of the locking pins.

In preferred variants, the at least one camera can be attached to the winch carrier or to the load suspension apparatus and can be oriented so as to look vertically downward. If the camera is situated, or if the cameras are situated, on the load suspension apparatus, the orientation of the crane or the load suspension apparatus relative to the load to be suspended, preferably relative to the semi-trailer and/or container to be suspended, favorably takes place in an operating state, in which the load suspension device is situated at a previously determinable starting height, for example at the maximum possible height.

In preferred embodiments, the winch carrier is mounted or suspended rotatably on the crane trolley. The term of “winch carrier” is to be understood generally. It is that region of the crane which is fastened to the crane trolley and on which the cables, on which the load suspension apparatus is suspended, can be wound up and/or unwound and/or deflected. The winch carrier can have a building-like structure which is closed to the outside, and can be called a winch house. The winch carrier can also, however, be configured as a completely or partially open structure and especially not in a building-like manner.

The control stand can be connected fixedly to the winch carrier and can be arranged in an elevated position on the crane. Within the context of the invention, however, mobile control stands are also conceivable, for example, which the crane driver can then also carry around with themselves, for example. The control stand can also be, for example, a remote control stand which is arranged at a distance from the crane in a building, however. At any rate, the at least one screen which displays the images recorded instantaneously by the at least one camera is integrated into the control stand, the at least one assistance graphic simply being superimposed into these images according to the invention.

The assistance graphic can be, for example, at least one assistance line for orienting on a gripping edge of the load to be gripped, in particular of the semi-trailer and/or container to be gripped. However, the assistance graphic can also comprise, for example, two assistance lines which are oriented orthogonally with respect to one another for orienting on a corner of the load to be gripped, in particular of the semi-trailer and/or container to be gripped. For example, a U-shaped form of the assistance graphics is also possible, however.

Generally speaking, the shape of the assistance graphic is favorably adapted to the shape of the load to be suspended, or else can be adapted in a flexible manner. The position, orientation and possibly also the size and the shape of the assistance graphic can be configured such that they can be calibrated. It can thus be provided that the assistance graphic is first of all calibrated using calibrating bodies such as, for example, a certain type of a container or semi-trailer or a different type of load or the position and the shape of specific markings on the load, in order thus to then subsequently be adapted specifically to this type of load, in particular semi-trailer and/or container, and/or marking.

It is also possible for the assistance graphics not to be superimposed permanently but rather only temporarily, in particular only when they are actually required. It can be provided, for example, that the assistance graphic or graphics can be superimposed and suppressed in a situational and/or dynamic manner, for example by the crane driver and/or in an automated manner by a crane controller. It is equally possible for a plurality of different assistance graphics to be stored for different road types in such a way that the crane driver can select and superimpose that auxiliary graphic or those auxiliary graphics which they currently require for a certain type of load. An animated (for example, by a crane controller), that is to say moving, embodiment of the assistance graphics is also possible.

In addition to the assistance graphics, information and/or displays of other assistance systems can also be displayed on the at least one screen in preferred embodiments of the invention. It is thus conceivable, for example, for distance information, for example from the underlying surface, different constituent parts of the crane according to the invention such as, for example, the entire crane and/or the crane trolley and/or the winch carrier and/or the load suspension apparatus and/or the gripping tools and/or also the load and the like to also be superimposed. Animated, that is to say moving, illustrations are also possible here. Thus, for example, tong arms and/or other gripping tools can be shown such that they move toward one another and away from one another.

Technology, already known per se in the prior art, in the form of what is known as micromotion can also be realized in the case of cranes according to the invention. This is precision positioning of the load suspension apparatus in the horizontal and vertical direction, and with regard to an orientation of the load as a result of tilting and/or pivoting of the load.

The number and positioning of the cameras on the crane can vary. Particularly preferred variants of the invention provide that for cameras which are oriented so as to look vertically downward are attached spaced apart from one another to the winch carrier and/or to the load suspension apparatus, and the respective instantaneously recorded images of the four cameras can be displayed in four separate sectors next to one another on the screen together with in each case at least one superimposed assistance graphic.

Generally speaking, it might also be said that a plurality of cameras which are oriented so as to look vertically downward are attached distanced from one another to the load suspension apparatus, and the respective instantaneously recorded images of the cameras preferably being capable of being displayed in a plurality of separate sectors next to one another on the screen together with the respective at least one superimposed assistance graphic. The cameras can be arranged, for example, in corner regions of the winch carrier and/or the load suspension apparatus.

Cranes according to the invention can have one or else more main carriers which can be moved to and throw along the first direction. It is provided in the case of one particularly preferred crane according to the invention that it has two main carriers which can be moved back and forth along the first direction and on which the crane trolley is mounted such that it can be moved back and forth along the second direction.

It is provided in the case of particularly preferred embodiments of the invention that the crane is a gantry crane with vertical supports which can be moved on wheels, the main carrier or carriers being mounted on the vertical supports and being capable of being moved back and forth along the first direction together with the vertical supports on the wheels. Another variant according to the invention provides that the crane is an overhead crane, the main carrier or carriers being capable of being moved back and forth along the first direction on guide rails by means of wheels.

### BRIEF DESCRIPTION OF THE DRAWINGS

Further features and details of preferred embodiments of the invention will be explained by way of example in the following text on the basis of exemplary embodiments. In the drawing:

FIGS. 1 to 3 show different views of a crane according to the invention which is configured as a gantry crane,

FIG. 4 shows a diagrammatic illustration with respect to the arrangement of the main carriers, the crane trolley, the winch carrier and the load suspension apparatus of the crane which is shown in FIGS. 1 to 3,

FIG. 5 shows a schematic view from below of the winch carrier and the load suspension apparatus of the crane from FIGS. 1 to 3,

FIGS. 6 to 8 show illustrations with respect to the load suspension apparatus which is used in the case of this crane,

FIG. 9 shows a diagrammatic illustration of how images can be recorded in four separate sectors arranged next to one another by way of four cameras arranged on the winch carrier of this crane,

FIGS. 10 to 30 show different loading situations, in the case of which the superimposition of assistance graphics into the recorded images is used according to the invention,

FIG. 31 shows an illustration with respect to the use of the gripping tools which are configured as tong arms with the cameras arranged there,

FIGS. 32 and 33 show two images assigned to different situations according to FIG. 31, and

FIG. 34 shows a crane according to the invention which is configured as an overhead crane.

### DETAILED DESCRIPTION

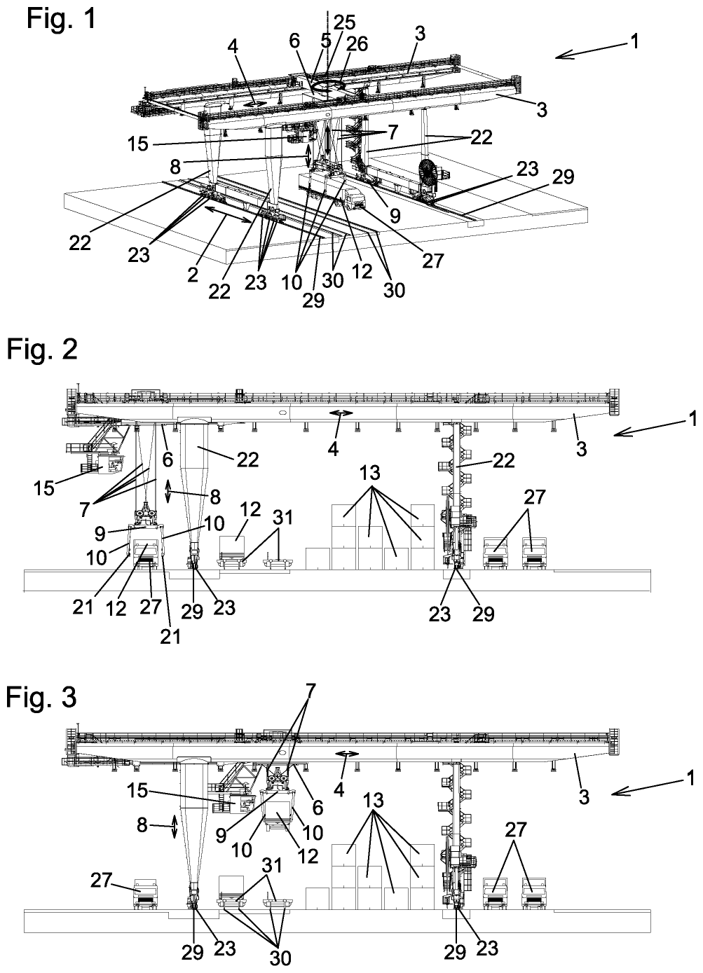

FIG. 1 shows a perspective view obliquely from above of a crane 1 according to the invention which is configured in this exemplary embodiment is a gantry crane. In addition to some details which are not essential to the invention, are known per se, and will not be explained further here, this crane 1 has in the first place, above all, two main carriers 3. These main carriers 3 are mounted on vertical supports 22. Wheelsets with in each case a plurality of wheels 23 are situated at the lower ends of the vertical supports 22. The main carriers 3 are mounted such that they can be moved back and forth in the first direction 2 by means of the wheels 23. In the exemplary embodiment which is shown, this is a rail-mounted system, in the case of which the wheels 23 lie movably on crane rails 29. It is just as possible, however, that the wheels 23 have, for example, a corresponding air-mounted or rubber-mounted tire set, by way of which they can move simply on a correspondingly flat underlying surface.

A crane trolley 5 is mounted on the two main carriers 3 such that it can be moved back and forth along the second direction 4. The first direction 2 and the second direction 4 are oriented orthogonally with respect to one another. As is known per se, a winch carrier 6 (configured in this example as a winch house) is mounted on the crane trolley 5 (rotatably in this exemplary embodiment). The winch carrier 6 can be rotated relative to the crane trolley 5 about the rotational axis 25 in the rotational directions 26 which are opposed with respect to one another. A load suspension apparatus 9 hangs on the winch carrier 6 by means of cables 7 in a way known per se. By way of corresponding winding up and unwinding of these cables 7 on cable drums (not shown explicitly here), the load suspension apparatus 9 can be moved up and down in the vertical direction 8. The load suspension apparatus 9 has different gripping tools 10 and 11 for releasably gripping a semi-trailer 12 and/or container 13, as will be explained in detail further below. Furthermore, the crane 1 according to the invention also comprises a plurality of cameras 14, the arrangement and function of which will likewise be explained in detail further below. In this exemplary embodiment, the control stand 15 of the crane is connected fixedly to the winch carrier 6. The control stand 15 comprises all the aids which the crane driver needs to move the at least one main carrier 3, the crane trolley 5 and the load suspension apparatus 9, and to operate the gripping tools 10 and 11 of the load suspension apparatus 9. Inter alia, the control stand 15 also comprises at least one screen 17 for displaying the respective image 16 recorded instantaneously by the respective camera 14 or the cameras.

As has already been explained at the outset, the control stand 15 of course does not have to be realized fixedly on the winch carrier 6, as configured in this exemplary embodiment. Rather, it can also be a mobile control stand 15, in particular also a control stand 15 which is portable in a mobile manner by the crane driver, which is also known per se nowadays for actuating cranes. Moreover, as has already been stated, the control stand can also, however, be a remote control stand which is arranged at a distance from the crane 1 in a building, for example.

FIG. 1 also shows a truck 27 with a semi-trailer 12, on which the gripping tools 10, which are configured as tong arms, of the load suspension apparatus 9 act especially in FIG. 1. In addition to the truck 27, railway tracks 30 are also provided in the region between the crane rails 29 in the exemplary embodiment according to FIG. 1, on which railway tracks 30 corresponding railway trailers 31 can be provided for loading semi-trailers 12 and containers 13 or else other loads.

FIGS. 2 and 3 show this crane 1 from FIG. 1, in each case in a side view. In FIGS. 2 and 3, various containers 13 are stacked in the region between the crane rails 29. Railway trailers 31 are situated on the railway tracks 30, a semi-trailer 12 currently being situated on one of these railway trailers 31, while the other railway trailers 31 is still free. FIG. 2 shows the situation, in which the gripping tools 10 in the form of the tong arms of the load suspension apparatus 9 are pivoted apart from one another in such a way that the load suspension apparatus 9 can be lowered further in the vertical direction 8. The gripping tools in the form of the tong arms 10 are subsequently pivoted toward one another, with the result that the tong bases 21 grip the semi-trailer 12. FIG. 3 shows how the semi-trailer 12 is already raised by means of the load suspension apparatus 9 and is positioned above the railway trailer 31 which is still empty.

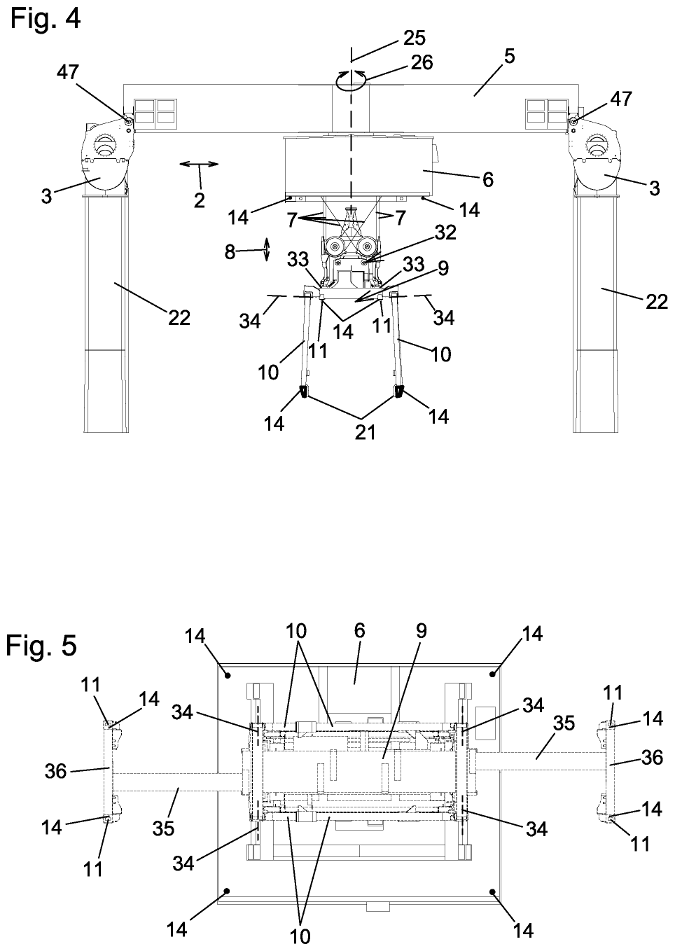

FIG. 4 then shows a schematic view, in the case of which the second direction 4 lies perpendicularly on the plane of the drawing. The two main carriers 3 of the crane 1 and their running rails 47 are shown, on which running rails 47 the crane trolley 5 is mounted such that it can be moved back and forth along the second direction 4. The winch carrier 6 is attached to the crane trolley 5, to be precise in such a way in this exemplary embodiment that it can be rotated relative to the crane trolley 5 about the vertical rotational axis 25 in the rotational directions 26. The load suspension apparatus 9 hangs on the winch carrier 6 by means of cables 7 in a way known per se. It is specifically provided here that a roller deck 32 which realizes the connection between the cables 7 and the load suspension apparatus 9 is situated on the load suspension apparatus 9. Roller decks 32 of this type and also a very wide variety of different types of cable suspension means for the load suspension apparatus 9 are known per se and do not have to be explained here. A roller deck 32 can of course also be dispensed with, for example by it being provided that the cables 7 are fastened directly to the load suspension apparatus 9 by means of anchor points or pulleys or the like.

In order for it to be possible for both semi-trailers 12 and containers 13 to be gripped, the load suspension apparatus 9 of this exemplary embodiment has different gripping tools 10, 11. These are firstly the gripping tools 10 which are configured as tong arms for receiving a semi-trailer 12, and secondly the gripping tools 11 which are configured as locking pins or as twistlocks for receiving a container 13. Tong arms and locking pins of this type are likewise known per se and do not have to be explained in greater detail. FIG. 4 also illustrates the first pivot axes 33 and the second pivot axes 34. The gripping tools 10 which are configured as tong arms can be pivoted toward one another and away from one another in a way known per se about the first pivot axes 33, in order thus to be able to grip and also to release a semi-trailer 12. The gripping tools 10 in the form of the tong arms are then pivoted about the second pivot axes 34 if they are not required; for example, in situations in which a container 13 is to be gripped by means of the gripping tools 11. The pivoting of the tong arms or gripping tools 10 about the second pivot axes 34 is also known per se and does not have to be explained in further detail.

Even if the invention can be implemented with a minimum number of only one camera 14, a multiplicity of cameras 14 are also provided in this exemplary embodiment. Four cameras 14 which look vertically downward and are spaced apart from one another are the situated on the lower side of the winch carrier 6. These four cameras 14 are preferably attached in each case in one of the corners of the winch carrier 6. The load suspension apparatus 9 in this exemplary embodiment additionally also has four further cameras 14. Each of these cameras 14 is situated in the immediate vicinity of one of the gripping tools 11, configured as locking pins, on gripper carriers 36, which can be retracted and extended here by means of the telescopes 35, of the load suspension apparatus 9. In this exemplary embodiment, however, in each case one camera 14 which looks to the side in the horizontal direction is also additionally arranged on the gripping tools 10, configured as tong arms, in the vicinity of the tong bases 21.

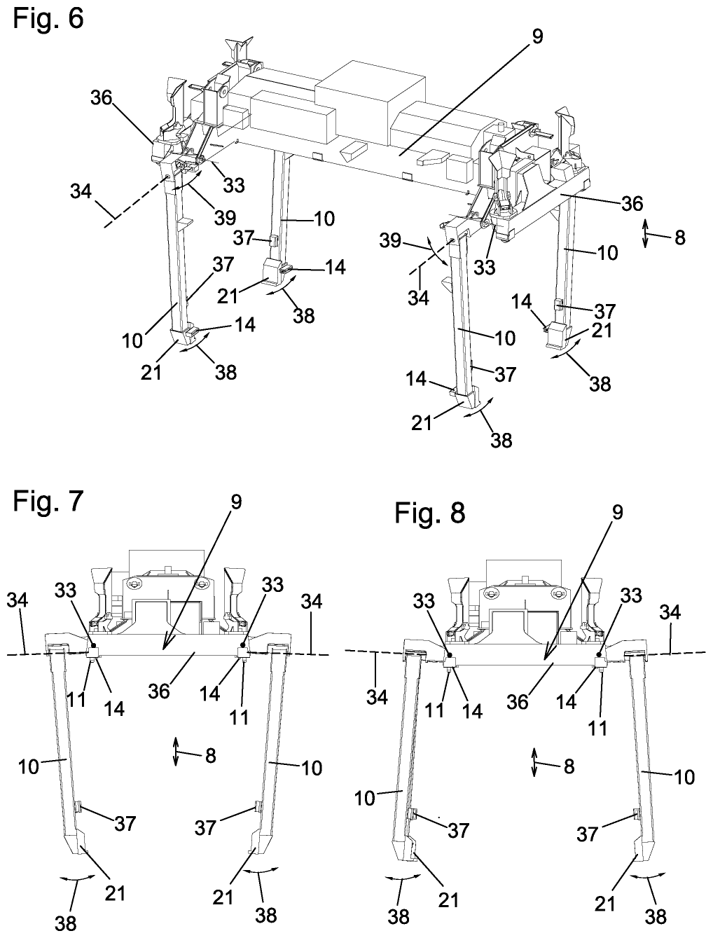

FIG. 5 shows a view from below of the winch carrier 6 and the load suspension apparatus 9 which is arranged underneath it. Here, the position both of the cameras 14 on the winch carrier 6 and also of the cameras 14 on the load suspension apparatus 9 or its gripper carriers 36 can be seen clearly. The telescopes 35 are shown schematically here, but are known per se in the prior art. They allow the gripper carriers 36 with the gripping tools 11 arranged on them in the form of the locking pins to be retracted and extended, in order thus to adapt the length of the load suspension apparatus 9 to the length of the respective container 13 to be received. FIG. 5 shows the gripping tools 10 in the form of the tong arms pivoted upward about the second pivot axes 34. They are therefore situated in FIG. 5 in the in active position which is used to load containers 13 by means of the load suspension apparatus 9.

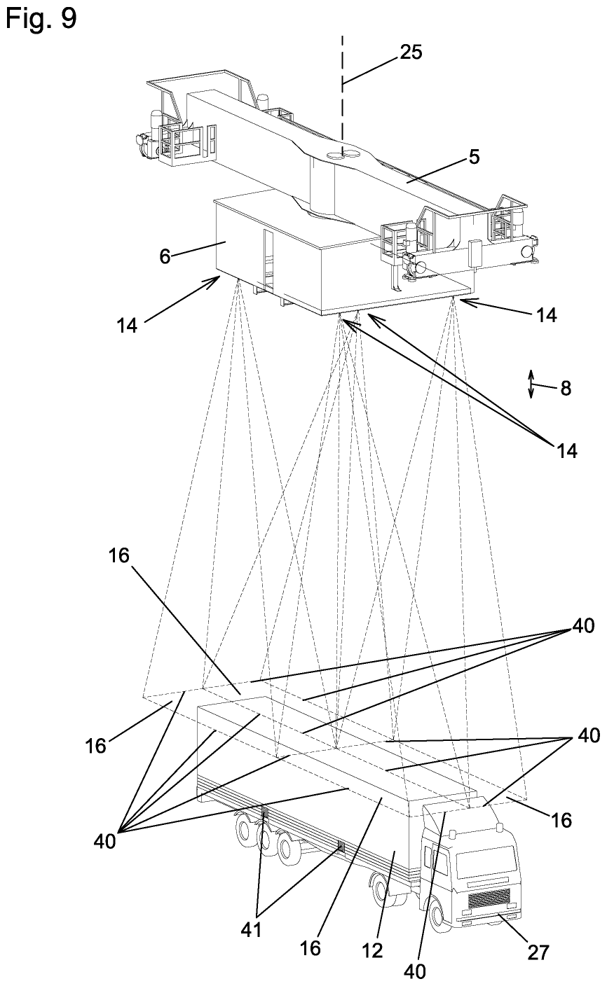

FIG. 6 shows the load suspension apparatus 9 in a perspective illustration, the gripping tools 10 in the form of the tong arms being pivoted downward into their active position, in which they can grip semi-trailers 12. The pivoting of the tong arms or gripping tools 10 toward one another and away from one another about the first pivot axis 33 takes place in the first pivoting directions 38 in order to grip or to release the semi-trailer 12. The pivoting in the second pivoting directions 39 about the second pivot axes 34 takes place in order for it to be possible for the gripping tools 10 in the form of the tong arms to be pivoted back and forth between their active position which is shown in FIG. 6 and there inactive position which is shown in FIG. 5. The position of the cameras 14 which are attached to the gripping tools 10 in the vicinity of the tong bases 21 can also be seen clearly in FIG. 6, the method of operation of which cameras 14 will be explained further below. Additional cameras 37 are also shown which have to be present, but are not as a rule used to implement the invention. The tong bases 21 are favorably (as is also shown) of hook-shaped configuration, in order that they can engage behind corresponding gripping edges 19 of the semi-trailers 12 in a way known per se. Other fastening means of the gripping tools or tong arms 10 to the semi-trailers 12 are of course also conceivable. The same applies to the gripping tools 11 for receiving containers 13. They therefore also do not necessarily have to be locking pins here. Other gripping tools 11 can also be used, in order to grip corresponding containers 13.

FIG. 7 shows the gripping tools 10 in the form of the tong arms at any rate pivoted toward one another about the first pivot axis 33, and FIG. 8 shows them pivoted away from one another.

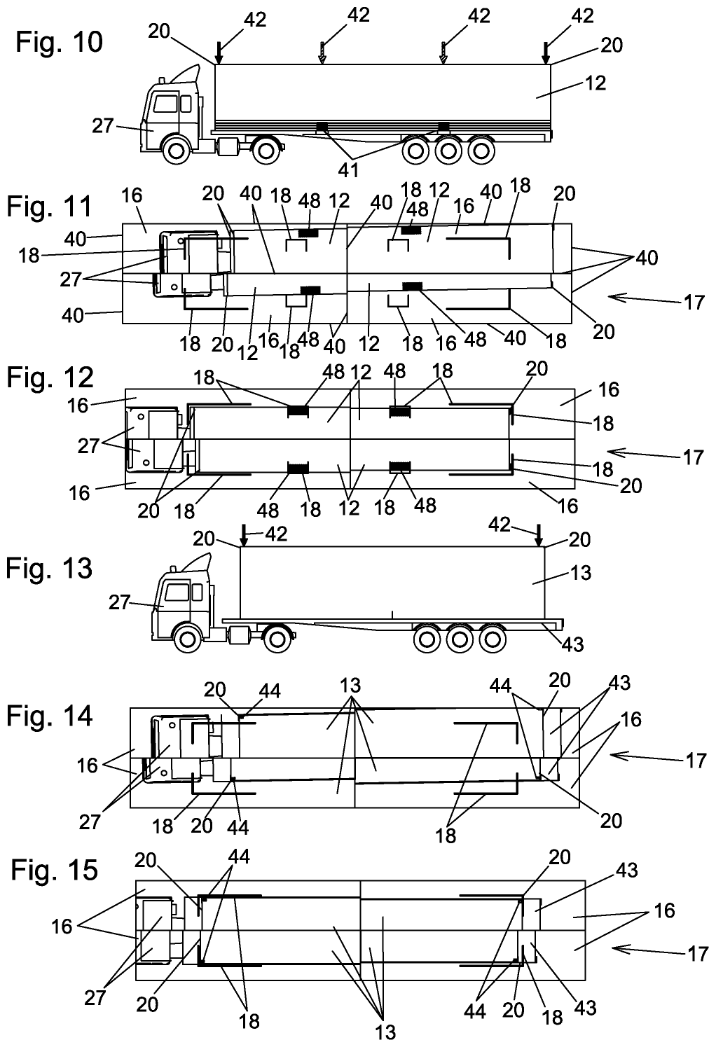

FIG. 9 then shows, in respect of the first exemplary embodiment of a crane 1 according to the invention, the crane trolley 5 and the winch carrier 6 arranged thereon with its four cameras 14 which are oriented so as to look vertically downward. The other components of the crane 1 and, in particular, the load suspension apparatus 9 are not shown in FIG. 9. In the case of the orientation which is depicted in the following text, the load suspension apparatus 9 is that any case in practice favorably moved vertically upward to such an extent that it does not disrupt the viewing angles, shown by means of dashed lines in FIG. 9, of the individual cameras 14 on the winch carrier 6.

In the situation which is shown in FIG. 9, the four cameras 14 on the winch carrier 6 which are oriented so as to look vertically downward in each case record images 16 in sectors which are separate from one another, which images 16 can then be shown jointly next to one another on a screen 17, as explained further below. FIG. 9 shows by way of example how images of the truck 27 which is arranged underneath with the semi-trailer 12 can be recorded by means of the four cameras 14 from above in sectors which are arranged separately from one another but adjacently with respect to one another. The individual images 16 are delimited in each case by the image boundaries 40 in the recording plane which is shown.

Even if this is not shown here, four corresponding images of the semi-trailer 12 and the truck 27 might be recorded in an analogous way by means of the cameras 14 arranged on the load suspension apparatus 9. To this end, the load suspension apparatus 9 is favorably moved into a predefined starting position, particularly preferably precisely into the maximum height below the winch carrier 6, in order that the crane driver can then orient the load suspension apparatus 9 and/or the gripping tools 10 or 11 of the load suspension apparatus 9, for example, relative to the semi-trailer 12 to be gripped and, in an analog way, precisely also, for example, relative to a container 13 to be gripped.

It will now be depicted in the following text how, in different situations, the crane driver can orient the load suspension apparatus 9 and/or the gripping tool 10 or 11 of the load suspension apparatus 9 relative to the semi-trailer 12 and/or container 13 to be gripped according to the invention with the aid of assistance graphics 18 which are superimposed into the images 16.

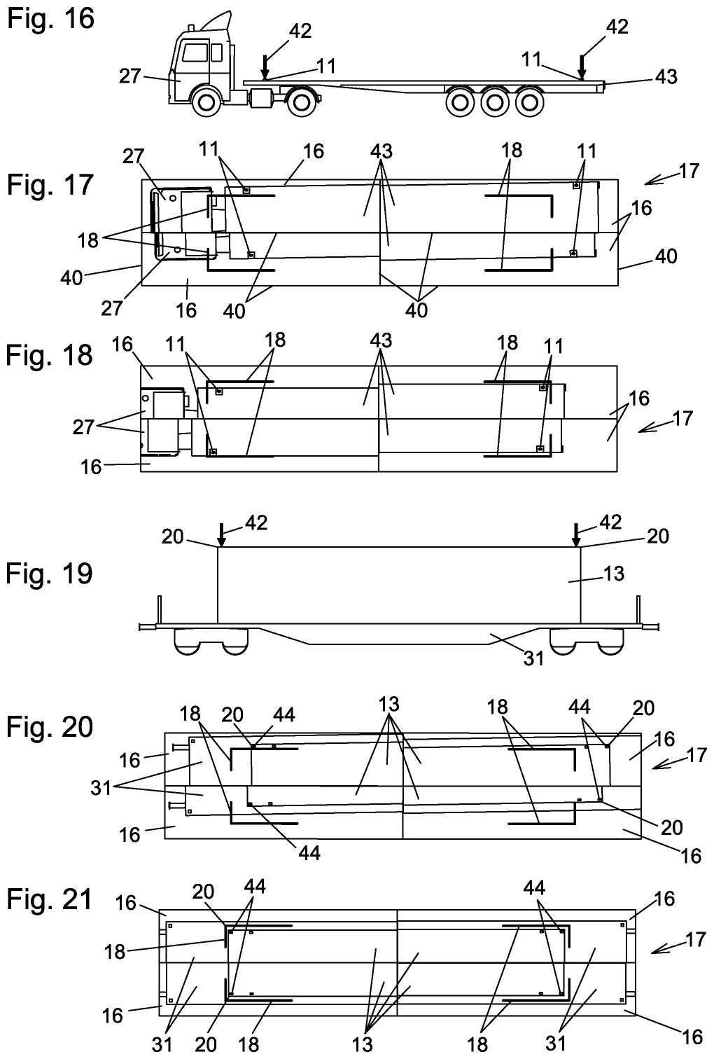

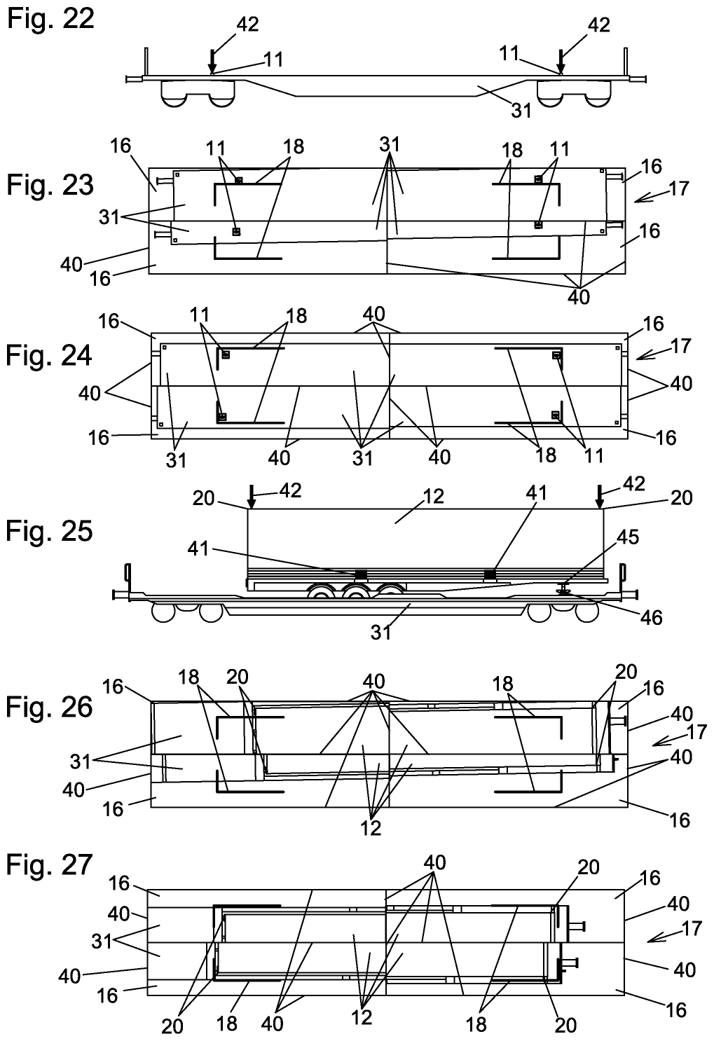

To this end, FIG. 10 first of all shows a side view of a semi-trailer 12 which is pulled by means of a truck 27 and can be parked, in order to load the semi-trailer 12, in a region, in which the crane 1 can receive and accordingly load the semi-trailer 12 by means of the load suspension apparatus 9. Color plates 41, the function of which will be described in detail further below on the basis of FIGS. 31 to 33, are situated on the sides of the semi-trailer 12.

First of all, the crane driver has the task, in the case of preferably fully upwardly moved load suspension apparatuses 9, of positioning the load suspension apparatus 9 above the semi-trailer 12 to be loaded, in such a way that the load suspension apparatus 9 can subsequently be lowered with its gripping tools 10 in the form of the tong arms onto the semi-trailer 12 in such a way that the semi-trailer 12 is oriented between the gripping tools 10 in the form of the tong arms in an optimum manner for gripping the semi-trailer 12.

FIG. 11 then schematically shows an illustration of the screen 17 of the control stand 15, on which, in this exemplary embodiment as shown in FIG. 9, the four instantaneously recorded images 16 of the four cameras 14 on the winch carrier 6 are shown next to one another. At least one assistance graphic 18 is superimposed into each of the images 16 as aid for the crane driver for orienting the load suspension apparatus 9 and/or the gripping tool 10 or 11 of the load suspension apparatus 9. In this example, the respective assistance graphics 18 are in the first place in each case two assistance lines which are oriented orthogonally with respect to one another and serve for orientation on each case one corner 20 of the semi-trailer 12. Each of the images 16 shown on the screen 17 is delimited by its image boundaries 40. In FIG. 10, the arrows 42 in the vicinity of the corners 20 show that plane on the upper edge of the semi-trailer 12 which is observed by the crane driver during the orienting operation which is depicted in the following text. This is the plane, in which the upper corners 20 of the semi-trailer 12 lie. FIG. 11 then shows the starting situation, in which the which carrier 6 and therefore the load suspension apparatus 9 which is still pulled upward are not yet oriented above the semi-trailer 12 in a suitable way, in order for it to be possible for the load suspension apparatus 9 to be moved down onto the semi-trailer 12 in such a way that the latter can be gripped by means of the gripping tools 10 in the form of the tong arms.

FIG. 11 in the following figures also show by way of example that the four images 16 shown on the screen 17 do not necessarily have to be oriented relative to one another in such an optimum way that they show the parts represented in each case in them of the semi-trailer 12 or truck 27 without offset. An officer which is shown by way of example in FIG. 11 does not disrupt the method depicted in the following text in the case of the orientation.

If the screen 17 which is shown in FIG. 11 is considered, the crane driver at any rate detects in a simple way that the outlines of the semi-trailer 12 and, in particular, its corners 20 do not yet lie in a suitable way in congruence with the assistance graphics 18 which are to be assigned to the corners 20. There crane driver can gather from FIG. 11 in a simple way that the load suspension apparatus 9 first of all has to still be oriented relative to the semi-trailer 12 before the load suspension apparatus 9 can be moved down onto the semi-trailer 12 in order to receive the latter. For orientation purposes, the crane driver can move the crane 1 along the first direction 2 and the crane trolley 5 along the second direction 4 in such a way that the outer contours and, in particular, the corners 20 of the semi-trailer 12 come to lie sufficiently in congruence with the assistance graphics 18 which are superimposed into the images 16. Here, the winch carrier 6 can optionally also be rotated about the rotational axis 25 in one of the rotational directions 26 relative to the crane trolley 5 if this is necessary for optimum orientation. In the case of the orientation of the load suspension apparatus 9, as shown in FIG. 12, ideal congruence does not necessarily have to be achieved. It is sufficient if the outer contours which can be seen in the images 16, in particular corners 20, of the semi-trailer 12 come to lie as symmetrically as possible with regard to the assistance graphics 18. If the state as shown by way of example in FIG. 12 is achieved, the winch carrier 6 is positioned with the load suspension apparatus 9 above the semi-trailer 12 in an optimum manner for the following loading operation. The load suspension apparatus 9 can then be lowered, as a result of which the semi-trailer 12 comes to lie between the grippers 10 in the form of the tong arms in a satisfactorily positioned manner for the subsequent gripping operation.

If the images 16 recorded by means of the cameras 14 on the winch carrier 6 are not used, but rather the images 16 of the cameras 14 which are arranged on the load suspension apparatus 9, this results ultimately in the same operation; the load suspension apparatus 9 should simply be situated during the orientation at a predefinable starting height, preferably at the maximum possible height, above the semi-trailer 12. For this starting height, the corresponding assistance graphics 18 can then also be superimposed correspondingly into the images 16.

Semi-trailers 12 with color plates 41 can also have additional markings 48 on their roof, which additional markings 48 make the position of the color plates 41 recognizable for the crane driver even in a view from above. Markings 48 of this type are additionally illustrated in FIGS. 11 and 12. Their position is identified in FIG. 10 by way of the hatched arrows 42 which lie further to the inside. These markings 48 can likewise be used for being oriented on correspondingly arranged assistance graphics 18 configured here in FIGS. 11 and 12 in each case by way of example in a U-shaped manner. It is at the discretion of the crane driver whether the crane driver then uses the assistance graphics 18 configured for the corners 20 or the assistance graphics 18 configured for the markings 48 or both types of assistance graphics 18 for the above-depicted process of the orientation of the load suspension apparatus 9.

FIGS. 13 to 15 then illustrate the same procedure when it is not a semi-trailer 12 but rather a container 13 which is shown in a side view in FIG. 13 and is arranged on a low-loader 43 of the truck 27 is to be received unloaded. In FIG. 13, the arrows 42 once again show the plane in the region of the upper edges 20 of the container 13, which plane is decisive in the consideration of the images 16 for the depicted orientation operation.

FIG. 14 shows the images 16, shown on the screen 17, of the camera 14 of the winch carrier 6 before the orientation of the winch carrier 6 with the load suspension apparatus 9 relative to the container 13. In FIG. 14, the crane driver readily recognizes on the basis of the assistance graphics 18 that the load suspension device 9 is not yet positioned in a suitable way above the container 13. By way of corresponding moving of the crane 1 along the first direction 2, the crane trolley 5 along the second direction 4 and possibly with the necessary rotation of the winch carrier 6 about the rotational axis 25, the crane driver can then move the winch carrier 6 with the load suspension apparatus 9 until the situation shown in FIG. 15 is achieved. In FIG. 15, the outer contours of the container 13 lie with its corners 20 in an optimum manner between the assistance graphics 18 which are superimposed into the images 16, with the result that the crane driver then recognizes in a simple way that the load suspension apparatus 9 is oriented above the container 13 sufficiently precisely for the following loading operation. If the situation according to FIG. 15 is achieved, the load suspension apparatus 9, with gripper carriers 36 which are extended far so as to correspond to the length of the container 13, can be lowered onto the container 13 in such a way that the gripping tools 11, arranged on the gripper carriers 36, in the form of the locking pins or twistlocks can be inserted into the corner fittings or corner casts 44 of the container 13 and can be locked there. Subsequently, the container 13 can be raised from the low-loader 43 in a manner which is suspended on the load suspension apparatus 9. The gripping tools 10, which are not required for this loading operation of the container 13, in the form of the tong arms are pivoted here into their above-explained inactive position, with the result that they do not impede the gripping of the container 13 with the gripping tools 11 in the form of the locking pins.

While, in FIGS. 13 to 15, a container 13 is to be unloaded from a low-loader 43 of a truck 27, FIGS. 16 to 18 show by way of example the situation when the load suspension apparatus 9 with a container 13 fastened to it is to be positioned above an empty low-loader 43 in such a way that the container 13 can subsequently be loaded onto the low-loader 43. To this end, the crane driver then has to consider the plane, illustrated by the arrows 42 in FIG. 16, in the region of the upper edge of the low-loader 43. Locking pins 11 are also situated on the low-loader 43 in this plane, by way of which locking pins 11 the container 13 can be fastened on the low-loader 43 with its corner fittings 44 arranged on the bottom side. FIG. 17 in turn shows the screen 17 with the four images 16 in the situation, in which the load suspension apparatus 9 is not yet oriented sufficiently satisfactorily above the low-loader 43. FIG. 18 shows the situation after a corresponding orientation of the load suspension apparatus 9 in the affected way above the low-loader 43. By means of the assistance graphics 18 which are superimposed into the images 16 and their position relative to the locking pins 11 on the low-loader 43, the crane driver recognizes that the load suspension apparatus 9 with the container 13 fastened to it is now positioned ideally or at least sufficiently satisfactorily above the low-loader 43, with the result that the load suspension apparatus 9 with the container 13 can subsequently be lowered onto the low-loader 43, in order to load the container 13 onto the low-loader 43.

FIG. 19 shows the situation when a container 13 is to be unloaded from a railway trailer 31. In this situation, the plane in the region of the upper end of the container 13 with the corners 20 is once again to be considered by the crane driver, see arrows 42. FIG. 20 in turn shows the screen 17 with the images 16 and the assistance graphics 18 superimposed into them before the orientation of the winch carrier 6 with the load suspension apparatus 9. FIG. 21 shows the state when, after moving the crane 1 along the first direction 2, the crane trolley 5 along the second direction 4 and possibly necessary rotation of the winch carrier 6 about the rotational axis 25, the load suspension apparatus 9 is again oriented sufficiently satisfactorily above the container 13. In the situation which is shown in FIG. 21, the outer contours of the container 13 and, in particular, the corner fittings 44 arranged on the corners 20 on the upper side of the container 13 lie sufficiently symmetrically within the regions labeled by means of the assistance graphics 18, with the result that the lowering of the load suspension apparatus 9 onto the container 13 and its fastening to the load suspension apparatus 9 and subsequent loading can subsequently take place.

FIG. 22 shows the situation, in which a container 13 is to be loaded onto an empty railway trailer 31. Here, the crane driver considers that plane on the upper edge of the railway trailer 31 which is labeled by way of the arrows 42 in FIG. 22 and in which the gripping tools 11 in the form of the locking pins for fastening the container 13 on the railway trailer 31 are also situated. FIG. 23 in turn schematically shows the screen 17 with the four images 16 arranged next to one another, and the assistance graphics 18 which are superimposed there in each case and which readily show the crane driver that the load suspension apparatus 9 with the container 13 hanging on it is not yet positioned sufficiently satisfactorily above the railway trailer 31. FIG. 24 shows how, after the corresponding moving of the crane 1, the crane trolley 5 and possibly necessary rotation of the winch carrier 6, the situation is achieved, in which the crane driver can detect on the basis of the superimposed assistance graphics 18 that the load suspension apparatus 9 is now oriented sufficiently satisfactorily for the following loading operation, that is to say the loading of the container 13 onto the railway trailer 31.

FIG. 25 shows the situation when a semi-trailer 12 is to be unloaded from railway trailer 31 or pocket wagon. The kingpin 45 of the semi-trailer 12 and the fifth wheel 46 of the railway trailer 31 which serve to fasten the kingpin 45 can also be seen, inter alia, in FIG. 25. During the orientation of the load suspension apparatus 9 above the semi-trailer 12, the upper boundary plane (labeled by means of the arrows 42 in FIG. 25) of the semi-trailer 12 is once again considered, in which plane the upper corners of the semi-trader 12 are also situated. FIG. 26 in turn shows by way of example the screen 17 with the four images 16 and the superimposed assistance graphics 18 in the state, in which the load suspension apparatus 9 is not yet oriented above the semi-trader 12. FIG. 27 shows the state after the orientation operation by way of corresponding moving of the crane 1, the crane trolley 5 and/or by way of corresponding rotation of the winch carrier 6. The crane driver in turn recognizes in FIG. 27 on the basis of the sufficiently satisfactorily oriented position of the corners 20 relative to the assistance graphics 18 that the load suspension apparatus 9 is now positioned and oriented sufficiently precisely above the semi-trader 12 for the following receiving operation.

FIG. 28 shows a situation, in which a corresponding semi-trader 12 is to be loaded onto a railway trailer 31. Here, the plane which is labeled by way of the arrows 42 in FIG. 28 is to be considered. FIG. 29 shows the not yet oriented state, and FIG. 30 again in an analogous way shows the correspondingly satisfactorily oriented state, in the case of which the semi-trader 12 can then be unloaded onto the railway trailer 31 by means of the load suspension apparatus 9.

In the examples which have been shown up to now purely for explanation purposes, four cameras 14 are always used, in order to display their images 16 jointly on a screen 17 of the control stand 15. This does not have to necessarily be the case. Even a single image 16 of a single camera 14 is fundamentally sufficient for the procedure according to the invention, four assistance graphics 18 then also being superimposed into this image 16, for example. For example, it would also be conceivable, however, to operate with only two cameras 14 and two correspondingly superimposed assistance graphics 18 into each image 16 of the two cameras 14, etc.

In the case of the examples which have been depicted up to now, the invention is used to orient the load suspension apparatus 9, before it is lowered onto the semi-trader 12 to be loaded or the container 13 to be loaded, sufficiently satisfactorily above the latter. It will now be explained in the following text on the basis of FIGS. 31 to 33 how the invention can be used to help the crane driver to position the gripping tools 10, configured as tong arms, with the tong bases 21 in the region of the color plates 41 on the semi-trailer 12 in such a way that, during the subsequent pivoting of the tong arms toward the semi-trailer 12, the tong bases 21 act in an optimum manner on the gripping edges 19, provided correspondingly to this end, of the semi-trader 12, in order for it to be possible for the semi-trader 12 to subsequently be raised.

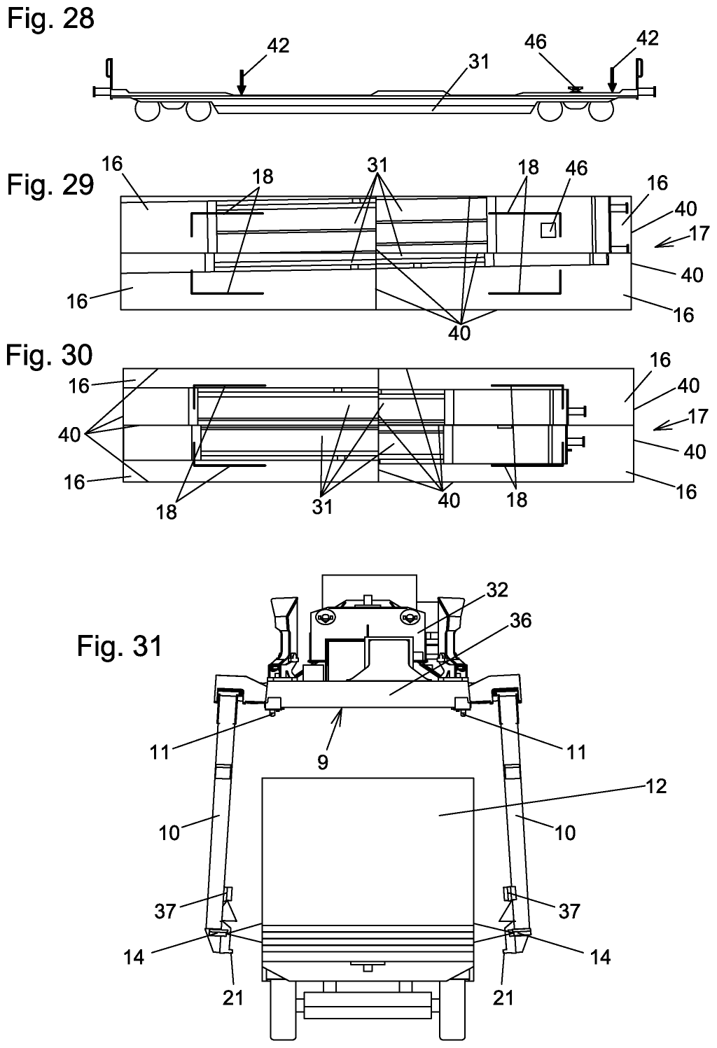

FIG. 31 shows the situation, in which the load suspension apparatus 9 with its pivoted-apart gripping tools 10 in the form of the tong arms is lowered onto the semi-trader 12 in such a way that the semi-trailer 12 comes to lie between the pivoted-apart tong arms. Here, the cameras 14 which are arranged on the tong arms or gripping tools 10 in the region of the tong bases 21 are used. They are arranged so as to look horizontally to the side, in such a way that they display an image 16 of the respective side wall of the semi-trailer 12. It is to be noted here that the cameras 14, as also realized in this example and as can be seen in FIG. 6, can also be attached in each case to the tong bases 21 in a somewhat laterally offset manner. The corresponding color plates 41, as are known in the prior art, are also situated on the sides of the semi-trailer 12 above the gripping edges 19, on which the tong bases 21 are to act. FIGS. 32 and 33 then show by way of example how an image 16 of each camera 14 of this type on the tong arm, that is to say a total of four images 16 in this example, are shown in each case on a screen 17 of the control stand 15. An assistance graphic 18 in the form of an assistance line is superimposed into each of these images 16. FIG. 32 shows the situation, in which the four tong arms are not yet positioned sufficiently satisfactorily relative to the side wall of the semi-trailer 12. The crane driver recognizes this from the fact that the assistance lines 18 do not yet lie in congruence with the respective gripping edge 19, but rather are still arranged in regions in the region of the respective color plate 41 by way of example in FIG. 32. The somewhat skewed illustration of the color plates 41 and the gripping edges 19 in the images 16 in FIG. 32 is a consequence of the above-depicted lateral attachment of the cameras 14 to the tong bases 21. In the case of a central arrangement of the cameras 14 on the tong bases 21, no oblique illustration or only an oblique illustration which is configured to a less pronounced extent would be observed. The same also applies to the images 16 in FIG. 33.

By way of corresponding lowering of the load suspension apparatus 9 and/or moving of the crane 1 along the first direction 2 and/or the crane trolley 5 along the second direction 4, the load suspension apparatus 9 can then be positioned in such a way that the tong arms with their tong bases 21 are positioned sufficiently satisfactorily relative to the semi-trailer 12 for the following gripping operation. This state is achieved when the assistance graphic 18 comes to lie on the gripping edge 19 or below it, as is shown in FIG. 33 for all four images 16 of the four cameras 14 on the four tong arms. If this state is achieved in the case of all four tong arms, they can be pivoted with their tong bases 21 toward the semi-trailer 12, with the result that the tong bases 21 engage behind the gripping edges 19 of the semi-trailer 12, and the semi-trailer 12 can subsequently be raised by way of the load suspension apparatus 9.

A corresponding camera 14 is favorably situated on each tong arm or gripping tool 10, such that, as shown in FIGS. 32 and 33, the result is four corresponding images 16 which are either shown, as shown in FIGS. 32 and 33, jointly on one screen 17 or on the screens 17 which are separate from one another, a corresponding assistance graphics 18 being superimposed in each case. On account of the given symmetries, however, it is fundamentally also conceivable for the procedure to be carried out according to the invention by way of only one, two or three cameras 14 and a corresponding number of images 16 on the corresponding tong arms.

The images 16 in FIG. 33 also illustrate that the gripping edges 19 do not have to come to lie exactly on the assistance graphics 18, in order that the crane driver can trigger the gripping operation. In the images 16 of FIG. 33, despite the skewed illustration and the inexact orientation of the assistance graphics 18 on the gripping edges 19, it can rather be seen clearly by the crane driver that a position is now achieved, in which the tong bases 21 are lowered to such an extent and are positioned sufficiently satisfactorily in that the gripping operation can be carried out. This is of course only one example for how the assistance graphics 18 can supply the information required by the crane driver even when no exact orientation takes place.

The additional cameras 37 which are also shown in FIG. 31 on the tong arms and which look vertically downward can be used as an additional safeguard and aid for the crane driver during lowering of the load suspension apparatus 9.

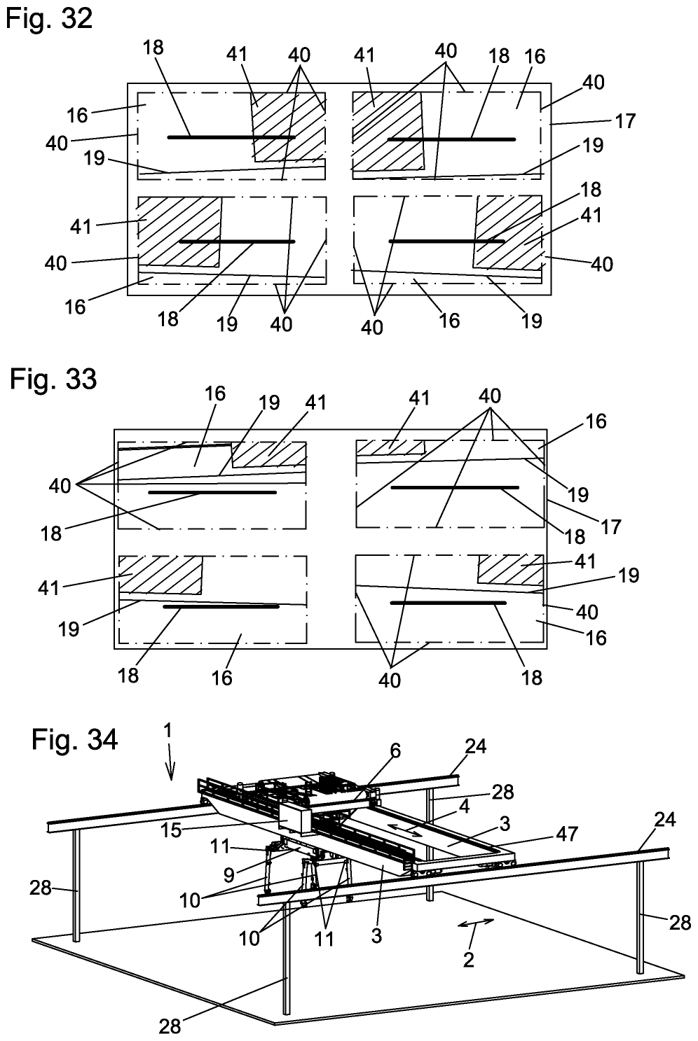

As has already been explained at the outset, cranes according to the invention do not necessarily have to be what are known as gantry cranes, as shown in the first exemplary embodiment. FIG. 34 shows by way of example what is known as an overhead crane, in the case of which the main carriers 3 are mounted such that they can be moved back and forth on guide rails 24 along the first direction 2 by means of wheels 23. The guide wheels 24 are mounted on a support structure 28 in FIG. 34. They can of course just as well be attached to building walls or the like, however. At any rate, the crane 1 which is configured as an overhead crane in FIG. 34 can be equipped with corresponding cameras 14 on the screen 17, etc., in an analogous manner to what has been explained in the case of the first exemplary embodiment, with the result that cranes 1 of this type can also be configured according to the invention and can be operated by means of methods according to the invention.

In the exemplary embodiments which are shown here, loads in the form of semi-trailers 12 and containers 13 are loaded according to the invention. The invention is of course not restricted thereto, however, but rather can also be used for loading other loads, in particular by way of correspondingly configured gripping tools.

### LIST OF ELEMENTS

| | |
|---|---|
| 1 | Crane |
| 2 | First direction |
| 3 | Main carrier |
| 4 | Second direction |
| 5 | Crane trolley |
| 6 | Winch carrier |
| 7 | Cable |
| 8 | Vertical direction |
| 9 | Load suspension apparatus |
| 10 | Gripping tool |
| 11 | Gripping tool |
| 12 | Semi-trailer |
| 13 | Container |
| 14 | Camera |
| 15 | Control stand |
| 16 | Image |
| 17 | Screen |
| 18 | Assistance graphic |
| 19 | Gripping edge |
| 20 | Corner |
| 21 | Tong base |
| 22 | Vertical support |
| 23 | Wheel |
| 24 | Guide rail |
| 25 | Rotational axis |
| 26 | Rotational direction |
| 27 | Truck |
| 28 | Support structure |
| 29 | Crane rail |
| 30 | Railway track |
| 31 | Railway trailer |
| 32 | Roller deck |
| 33 | First pivot axis |
| 34 | Second pivot axis |
| 35 | Telescope |
| 36 | Gripper carrier |
| 37 | Additional camera |
| 38 | First pivoting direction |
| 39 | Second pivoting direction |
| 40 | Image boundary |
| 41 | Color plate |
| 42 | Arrow |
| 43 | Low-loader |
| 44 | Corner fitting |
| 45 | Kingpin |
| 46 | Fifth wheel |
| 47 | Running rail |
| 48 | Marking |

1. A crane, comprising:
at least one main carrier which can be moved back and forth along a first direction;
a crane trolley which is mounted on the at least one main carrier for movement back and forth along a second direction, the first direction and the second direction being oriented orthogonally with respect to one another;
a winch carrier fastened to the crane trolley;
a load suspension apparatus that is moveable up and down in a vertical direction by cables hanging on the winch carrier, the load suspension apparatus (9) having gripping tools for releasably gripping a load;
at least one camera;
at least one control stand for a crane driver for moving the at least one main carrier, the crane trolley and the load suspension apparatus, and for operating the gripping tools of the load suspension apparatus;
the control stand having at least one screen for displaying an image recorded in instantaneously by the at least one camera; and
at least one assistance graphic superimposed on the at least one screen onto the display of the image that is recorded instantaneously by the at least one camera, the at least one assistance graphic providing an aid for orienting at least one of the load suspension apparatus or the gripping tool of the load suspension apparatus relative to the load to be gripped.

2. The crane as claimed in claim 1, wherein the assistance graphic comprises at least one assistance line for orienting on a gripping edge of the load to be gripped.

3. The crane as claimed in claim 1, wherein the assistance graphic comprises at least two assistance lines oriented orthogonally with respect to one another for orienting on a corner of the load to be gripped.

4. The crane as claimed in claim 1, wherein the at least one camera is attached to the winch carrier or to the load suspension apparatus, and is oriented to view vertically downward.

5. The crane as claimed in claim 1, wherein the at least one camera includes four cameras which are each oriented to look vertically downward and are attached spaced apart from one another to the winch carrier or to the load suspension apparatus, and respective instantaneously recorded ones of the images of the four cameras are displayable next to one another on the at least one screen together with in each case one of the at least one superimposed assistance graphic.

6. The crane as claimed in claim 1, wherein the load suspension apparatus has, as gripping tools, pivotably mounted tong arms for gripping a semi-trailer, and the camera is arranged on at least one of the tong arms and oriented to look horizontally toward a side.

7. The crane as claimed in claim 6, wherein the camera is arranged in a lower end region of the tong arm in a region of a tong base of the tong arm.

8. The crane as claimed in claim 1, wherein the at least one main carrier includes two main carriers which are moveable back and forth along the first direction and on which the crane trolley is mounted for movement back and forth along the second direction.

9. The crane as claimed in claim 1, wherein the crane is a gantry crane with vertical supports that are moveable on wheels, the at least one main carrier being mounted on the vertical supports and being moveable back and forth along the first direction together with the vertical supports on the wheels.

10. The crane as claimed in claim 1, wherein the crane is an overhead crane, the at least one main carrier being moveable back and forth along the first direction on guide rails by via wheels.

11. A method for operating a crane as claimed in claim 1, the method comprising:
superimposing the at least one assistance graphic on the at least one screen into the display of the respective image that is recorded in each case instantaneously by the at least one camera; and
orienting at least one of the load suspension apparatus or the gripping tools of the load suspension apparatus relative to the load to be gripped using the at least one assistance graphic superimposed into the display of the respective image.
